(19) United States
(12) Patent Application Publication
(10) Pub. No.: US 2007/0165982 A1
(43) Pub. Date: Jul. 19, 2007

(54) Expanding single-mode fiber mode field for high power applications by fusion with multi-mode fiber

(76) Inventors: Jan W. Kokkelink, Blairstown, NJ (US); Talal K. Findakly, Hacketistown, NJ (US)

Correspondence Address: FERRELLS, PLLC, P. O. BOX 312, CLIFTON, VA, 20124-1706, US

(21) Appl. No.: 11/714,388

(22) Filed: Mar. 6, 2007

Related U.S. Application Data
(63) Continuation-in-part of application No. 11/202,568, filed on Aug. 12, 2005.
(60) Provisional application No. 60/608,283, filed on Sep. 9, 2004.

(51) Int. Cl. G02B 6/42; G02B 6/26

(52) U.S. Cl. 385/38; 385/76; 385/77; 385/140; 385/39; 385/31; 385/43

(57) ABSTRACT

Apparatus and methodology for the low coupling of optical fibers in high power applications. An end of a single-mode optical fiber, or a polarization maintaining fiber, is cut and spliced to a relatively short segment of an index matched multi-mode fiber or an optical fiber without cladding (air cladded) having approximately similar diameter as the single-mode fiber which in turn is coupled to the external device. The free end of the multi-mode fiber may be cleaved, polished and have an anti-reflection applied to it. The beam emitted by the small core of the single-mode optical fiber expands into the larger core of the multi-mode fiber providing low loss high power coupling of the optical fiber to the external device. In applications with high power, where an unmodified fiber could be subject to damage, this component could function as a drop in replacement for that unmodified fiber, requiring no modification to the process or subsequent devices to which this fiber is attached.

### REFERENCE TO RELATED APPLICATIONS

This application is a continuation-in-part of U.S. patent application Ser. No. 11/202,568, of the same title, filed Aug. 12, 2005 which, in turn, was based upon U.S. Provisional Patent Application Ser. No. 60/608,283, filed Sep. 9, 2004. The priorities of U.S. patent application Ser. No. 11/202,568 and U.S. Provisional Patent Application Ser. No. 60/608,283 are hereby claimed and their disclosures incorporated into this application by reference.

### BACKGROUND OF THE INVENTION

This application relates to optical fibers, and more specifically to apparatus and methodology for the efficient coupling of optical fibers in high power applications.

High power performance of fiber lasers and fiber amplifiers is increasingly being required for a wide variety of applications and operating optical powers have increased enormously in recent years. Components used in these products are generally based on passive micro-optical parts assembled by attaching optical fibers (polarization maintaining fibers or single-mode fibers) to them through input and output lenses. Such components, originally designed for low power applications (typically in the mW range), are now required to operate at powers ranging from several watts to kW levels. These components are not designed for, and cannot reliably operate at, such high optical intensities. Many of the passive optical components used in these products require polished fiber ends, radiating into the air directly from the polished (or cleaved) fiber tip, through an anti-reflection (AR) coating directly deposited on the polished (or cleaved) fiber tip, or using an anti-reflection coated plate epoxied on the fiber tip (by way of example: a glass plate, previously anti-reflection coated, mounted to the end of the fiber with an index matching epoxy).

At these fiber tip junctions, the optical intensities are at their highest (reaching many GW/cm²), easily exceeding the maximum allowable damage levels of the bare fiber tip, the direct anti-reflection coating or anti-reflection plate bonding epoxy. Therefore, these points represent the weakest points in the transmission path and are likely to be damaged with the exposure to high optical power.

At present, there are two ways to reduce the optical intensity at the fiber tips in such situations. Firstly, by fusion splicing the optical fibers directly to the lenses, and secondly by means of locally expanding the fiber core by excessive localized thermal heating. The first solution has the drawback that the lens needs to match the index of the fiber perfectly (to reduce undesirable and problematic back reflections), resulting in limitations in choice of lens and lens performance. The fiber also needs to be placed exactly in the focus of the lens for optimum optical coupling, requiring tight tolerances in lens lengths and fiber to lens positioning. The process is also tedious and not cost effective.

The second solution has the drawback that the area over which the core is being expanded is relatively short, thus requiring great care when polishing or cleaving the fiber end, to avoid shortening the length over which the core is expanded. Shortening the length over which the core is expanded will reduce the size of the expanded beam, resulting in less than optimal reduction of the optical intensity. This process may also not be compatible with polarization maintaining fibers (PMF) because the severe thermal treatment will also deleteriously affect or destroy the internal stress originally induced and frozen into the polarization maintaining fiber thus severely reducing the polarization maintaining properties of the fiber. Furthermore, the fiber cores on both sides of the device need to be matched in mode size, and therefore also in the length over which the core is expanded, in order to optimize optical coupling.

While splicing of a (step index) multi-mode fiber to a single-mode fiber is known, e.g., U.S. Pat. No. 5,940,554 to Chang et al., it has not been heretofore appreciated that fiber splicing may be used as a power density reducing technique, making it possible to greatly reduce power density for single-mode fiber optic devices.

### SUMMARY OF THE INVENTION

The present application is directed to apparatus and methodology for the low loss coupling of optical fibers in high power applications. An end of a single-mode optical fiber, or a polarization maintaining fiber, is spliced to a relatively short segment of an index matched multi-mode fiber, (preferably a cladded step-index, multi-mode fiber or an optical fiber segment without cladding (air clad) having approximately a similar diameter as the single-mode fiber which in turn is coupled to an external device through lenses or other coupling mechanisms. The free end of the multi-mode fiber may be cleaved, polished and have an anti-reflection applied to it. The beam emitted by the small core expands in a natural and transparent way into the larger core of the multi-mode fiber providing low loss high power coupling of the optical fiber to the external device.

The approach described in this application reduces the light intensities at the fiber tip considerably as a result of beam expansion within the optical medium and can easily be implemented in existing production lines. Specifically, this approach has the following advantages and features: it substantially reduces the optical density at the fiber tip and does not introduce back reflections, due to the fiber end face; indeed back reflections are actually reduced. Additionally, the present approach is compatible with polarization maintaining fibers and single-mode fibers, is easy to implement using widely available tools and inexpensive to incorporate in assembly and production processes.

There is thus provided in accordance with the invention method of processing an optical beam having high optical power level comprising: (a) providing the optical beam to a single-mode optical fiber with cladding and a core joined to a step-index, multi-mode optical fiber segment at an interface therebetween, the step-index, multi-mode optical fiber segment being of a predetermined length and having an exposed terminus at an end thereof distal to the interface between the single-mode optical fiber and the step-index, multi-mode optical fiber segment. The optical beam and single-mode fiber are selected and configured such that the optical beam is guided in the single-mode optical fiber in single-mode form having a first mode diameter and wherein the optical power density in the core of the single-mode fiber is greater than 10 MW/cm². The optical beam is transmitted through the interface between the single-mode optical fiber and the step-index, multi-mode optical fiber segment to the step-index, multi-mode optical fiber segment where it is expanded larger than the first mode diameter of the beam, without distortion of the beam or introduction of additional fiber modes. The beam is transmitted through the exposed terminus of the step-index, multi-mode optical fiber segment at an optical power density less than that of the optical power density in the core of the single-mode fiber. Generally, the beam undergoes an optical power intensity reduction in the step-index, multi-mode optical fiber segment of between 10× and 1000×, typically of at least 50× or at least 100×. In some cases, the beam undergoes an optical power intensity reduction in the step-index, multi-mode optical fiber segment of at least 200×.

Generally, the step-index, multi-mode fiber segment has a length of less than 1 mm, such as a length of less than 0.75 mm. The single-mode optical fiber may be a polarization maintaining fiber and the exposed terminus of the step-index, multi-mode fiber may include an anti-reflection coating. The step-index, multi-mode fiber segment is suitably joined to the single-mode optical fiber by fusion splicing and is index matched to the single-mode optical fiber.

Optionally, the step-index, multi-mode optical fiber segment comprises an air clad optical fiber having approximately similar diameter as the single-mode fiber. In many applications, the inventive process includes the step of lensing the optical beam after it is transmitted through the exposed terminus of the step-index, multi-mode optical fiber segment.

In various embodiments, the optical power density in the core of the single-mode fiber is greater than 10 MW/cm² and less than 10 GW/cm². In some cases, the optical power density in the core of the single-mode fiber is greater than 500 MW/cm² and in still other optical power density in the core of the single-mode fiber is greater than 1 GW/cm².

Further details and advantages will become apparent from the description which follows.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a sectional view of the present invention as used with a single-mode (SM) optical fiber;

FIG. 2 is a sectional view of the present invention as used with a polarization maintaining (PM) optical fiber; and

FIG. 3 is a schematic view of the coupled fiber arrangement of FIG. 1, wherein a lens is used to collimate the light, exiting the step index MM fiber, so further processing within a device can be done.

### DESCRIPTION OF THE PREFERRED EMBODIMENTS

The invention is described in detail below for purposes of illustration only. Modifications within the spirit and scope of the present invention, set forth in the appended claims, will be readily apparent to those of skill in the art.

As used herein, terminology has its ordinary meaning, for example, mm means millimeter, nm means nanometer, MW means megawatts, GW means gigawatts and so forth as the context indicates.

“Single-mode” refers to the number of the modes allowed in a given fiber determined by a relationship between the wavelength of the light passing through the fiber, the core diameter of the fiber, and the material of the fiber. This relationship is known as the Normalized Frequency Parameter, or V number. The mathematical description of the V number is:
V=2*(π)*NA*a/λ

where:
NA=Numerical Aperture
a=fiber core radius (microns)
λ=wavelength (microns)
   A single-mode fiber has a V number that is less than 2.405. It will propagate light in a single guided mode. A multi-mode fiber has a V number that is greater than 2.405, and therefore will propagate in many paths through the fiber. Polarization maintaining (“PM”) fibers are single-mode fibers that maintain the polarization of light transmitted there through.

When we refer to a step-index, multi-mode optical fiber segment we mean an optical fiber segment which has a core of uniform index much larger than the core of the single-mode fiber to which it is joined. Typically, the core of the step-index, multi-mode optical fiber segment has a diameter more than 5× that of the single-mode fiber to which it is attached. From about 3 to about 20 times the diameter of the core of the single-mode fiber is suitable, depending on the type of single mode fiber used.

“Mode field diameter” means a characteristic number describing the size of the beam propagating through or exiting a fiber.

“Without distortion or introduction of additional fiber modes” means the single-mode character of the beam is substantially preserved. For example, a change in coupling loss between 2 similar fibers of less than about 0.1%-5% is indicative of no substantial distortion of the beam and substantial preservation of its single-mode character.

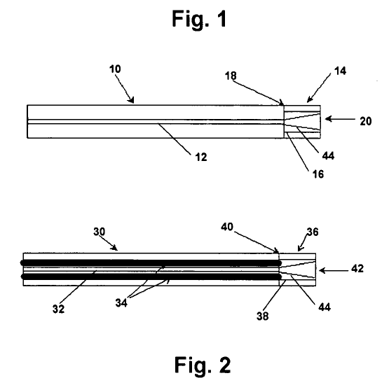

FIG. 1 illustrates the present invention as used with a single-mode fiber (SMF) 10 having a relatively small core 12 which is spliced end to end along a splice line 18 to a short length of a Multi-Mode fiber (MMF) 14 having a relatively large core 16, matching in index with the fiber 10, and a polished end 20. Multi-mode fiber 14 is preferably a step-index, multi-mode fiber, however, in certain applications, a graded index multi-mode fiber may also be used or an optical fiber without cladding (air clad) having approximately similar diameter as the single-mode fiber.

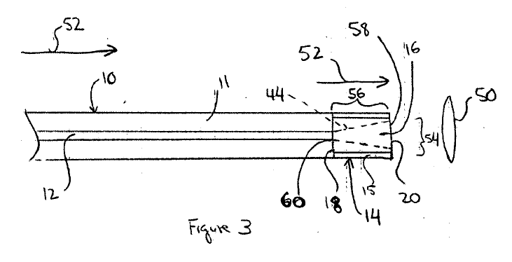

FIG. 2 illustrates the present invention as used with a Polarization Maintaining fiber (PMF) 30 having a relatively small core 32 and a pair of stress rods 34 which is spliced end to end along a splice line 40 to a short length of a multi-mode fiber 36 having a relatively large core, and matched in index with the PM fiber 38 and a polished end 42. Multi-mode fiber 36 is again preferably a step-index, multi-mode fiber, however, in certain applications, a graded index multi-mode fiber may also be used, or an optical fiber without cladding (air clad) having approximately similar diameter as the single-mode fiber. The splicing of the single-mode fiber 10 and Polarization Maintaining fiber 30 to Multi-mode fiber 14, 36 may be accomplished by standard splicing techniques known in this art, such as by fusion (arc) splicing.

Splicing a multi-mode fiber to the end of a single-mode fiber or a polarization maintaining fiber substantially reduces the light intensity at the fiber tip. The reason for this is that the splice point represents continuity between the two fibers (not an abrupt junction like the fiber-to-air junction) as the two fibers have nearly identical material. Therefore, this splice point will be transparent to the optical radiation and no optical damage can take place there. As the optical radiation leaves that point, the beam of the propagating single-mode will expand (shown at reference number 44) over the short distance it travels within the multi-mode fiber because the multi-mode fiber has a much larger core. By the time it reaches the multi-mode fiber end, the beam becomes considerably larger (while still in undistorted single-mode form) to where the optical density (or intensity) is now much smaller at the weak fiber/air junction. Following this concept, after splicing the two fibers, the fiber is cut (cleaved) a short distance beyond the splice junction on the multi-mode fiber side. This new tip is then polished (at the desired angle for the application at hand,-either perpendicular to the longitudinal axis of the multi-mode fiber or at an angle), and can be anti-reflection coated, if desired.

The issues to take into consideration in the design of the fibers of the present invention are: the multi-mode fiber core diameter and the length of the multi-mode fiber. The design goal is to ensure that the light is not guided by the multi-mode fiber but that the fiber mode can expand while staying smaller than the multi-mode core. With a proper choice of multi-mode fiber the core refractive indices of the single-mode/polarization maintaining fibers can be matched to the multi-mode fiber to ensure a minimal reflection from the fiber transition, if the index of the MM fiber does not perfectly match the index of the SM/PM fiber, the reflections from this transition can be minimized by angling the fiber ends before splicing them together. The actual length of the multi-mode e fiber is quite small, generally less than 1 mm, while the single-mode or polarization maintaining fibers can be of any length required by the task at hand.

In practical applications the larger the core of the multi-mode fiber, the more the mode can expand and thus reduce the intensity at the fiber tip. The optimal length of the fiber can be calculated and is determined by how much the mode expands in the index of refraction of the MM fiber. By way of example only, in many applications this will be a length of about 640 μm for 1550 μm wavelength light, for 980 μm wavelength light the fiber length is about 510 μm. A fiber without cladding (in other words with a cladding of air) is also suitable for this application.

The advantages of the present design are numerous. For polarization maintaining products, the stress members of the polarization retention properties of the Polarization Maintaining fibers are preserved because they (stress members) are not destructively perturbed. The Polarization Maintaining fibers are visible through the MM fiber; which facilitates fiber alignment during production. The length of MM fiber is not critical; making polishing the fiber relatively easy. Angle polishing of the fiber tip, done to reduce back reflections (also referred to as Return Loss), can be reduced. Smaller polish angles can improve optical performance and facilitate fiber to device alignment. The reflection requirements of the Anti Reflection (AR) coating can be lowered due to the presence of a short distance between the single-mode fiber/MM fiber F splice point and the end of the MM fiber end which reduces the coupled back reflection by virtue of the expanded beam profile. Also, the power handling requirements of the anti-reflection coating will be greatly reduced due to the expanded beam. The optical beam is collimated by a lens to facilitate the processing of the beam in a fiber optic device. If a fiber output is required for this device a mirrored setup will be used; a lens will now focus the beam through the MMF into the SM fiber FIG. 3.

FIG. 3 illustrates the present invention as used with a single-mode fiber having cladding 11 as well as a relatively small core 12 which is spliced end to end along a splice line 18 to a short segment 14 of a Multi-Mode fiber (MMF) having cladding 15 and a relatively large core 16, matching in index with the fiber 10, and a polished end 20. Multi-mode fiber segment 14 is a step-index, multi-mode fiber which communicates with a lens 50 which collimates and transmits the beam in the direction shown by arrows 52.

A SMF or PMF may be any suitable length, while the step index MMF segment has a core diameter and length such that the beam can expand to a maximum size, thus reducing the intensity when exiting the fiber. The beam must not expand to the point that the fiber starts guiding; this will distort the beam making it more difficult to couple back into a (output) fiber. The same is true when an unclad (air clad) glass segment is used; if the beam expands to the point that it reaches the edge (circumference) of the glass segment the beam will distort and not maintain its original shape.

The expansion of the optical beam, in the MM fiber segment, is such that the ratio of the optical power density of the beam at 58 to the optical power density of the beam at 60 in the core of SMF 10 is much less than 1 because of the difference in the core dimensions of the optical fibers. The invention is thus suitable as a drop in replacement for fibers, used in components that are subject to damage due to high intensities (power densities). No modification to (most) existing devices is necessary.

Table 1, below, lists some (approximate) operating parameters of spliced structures of the invention.

TABLE 1
Optical Power Reduction

| | | | | Optical Power | | Optical Power | | Optical | Damage |
|---|---|---|---|---|---|---|---|---|---|
| | | Power in | | Density in SMF | | Density at MMF | | Power | threshold |
| Fiber type | | fiber | | core at 60 | | Output at 58 | | Reduction | AR coating |
| 1550 | nm SMF | 1 | kW | 1.3 | GW/cm² | 16 | MW/cm² | 80× | 180 MW/cm² |
| 1060 | nm SMF | 1 | kW | 3.5 | GW/cm² | 16 | MW/cm² | 225× | 130 MW/cm² |
| 532 | nm SMF | 100 | W | 630 | MW/cm² | 1.6 | MW/cm² | 400× | 100 MW/cm² |

There is thus provided an apparatus for guiding an optical beam having high optical power levels including the steps of: (a) providing the optical beam to a single-mode optical fiber 10 with cladding 11 and a core 12 joined to a step-index, multi-mode optical fiber segment 14 at an interface 18 there between. The step-index, multi-mode optical fiber segment is of a predetermined length 56 and has an exposed terminus 58 at an end thereof distal to the interface 18 between the single-mode optical fiber and the step-index, multi-mode optical fiber segment. The optical beam and single-mode fiber are selected and configured such that the optical beam is guided in the single-mode optical fiber, having a first mode field diameter. In operation, the beam is transmitted through the interface 18 between the single-mode optical fiber 10 and the step-index, multi-mode optical fiber segment 14 to the step-index, multi-mode optical fiber segment 14. Thereafter, the beam is expanded in the step-index, multi-mode optical fiber segment 14 between the single-mode optical fiber/step-index, multi-mode optical fiber segment interface and the exposed terminus of the multi-mode fiber segment. The step-index, multi-mode optical fiber segment is sized and composed such that the beam can expand to a diameter, without guiding and thus without distortion, to a size significantly larger than the fiber mode field diameter at the terminus of the step index fiber. The expanded beam is transmitted through the exposed terminus 58 of the step-index, multi-mode optical fiber segment at an optical power density (or intensity) less than that of the optical power density (intensity) in the core of the single-mode fiber.

There is provided in various other aspects of the invention a method of providing a reduced optical power density terminus to a single-mode optical fiber comprising the step of splicing an index matched step-index, multi-mode fiber segment of a length of less than 1 mm to an end of the single-mode fiber, which single-mode optical fiber is a polarization maintaining fiber. The splicing step comprises fusion splicing in some cases and fabrication includes the step of polishing the free end of the step-index, multi-mode fiber segment as well as applying an anti-reflection coating to the polished free end of the step-index, multi-mode fiber segment.

An article of manufacture of the invention comprises: a) a single-mode optical fiber; b) a step-index, multi-mode optical fiber segment of a length of less than 1 mm joined to at least one end of the single-mode fiber. The free end of the step-index, multi-mode fiber is disposed perpendicular to the longitudinal axis of the multi-mode fiber in some cases as is appreciated from the drawings. Preferably, the step-index, multi-mode fiber is index matched to the single-mode optical fiber, to reduce/eliminate reflection from this interface, if perfect index matching is not possible an angle can be introduced at the SM/MM fiber interface. In one embodiment, the process includes the step of angling the (terminus of the) step-index, multi-mode fiber segment with respect to the single-mode optical fiber.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method of processing an optical beam having high optical power level comprising:
(a) providing the optical beam to a single-mode optical fiber with cladding and a core joined to a step-index, multi-mode optical fiber segment at an interface therebetween, the step-index, multi-mode optical fiber segment being of a predetermined length and having an exposed terminus at an end thereof distal to the interface between the single-mode optical fiber and the step-index, multi-mode optical fiber segment,
wherein the optical beam and single-mode fiber are selected and configured such that the optical beam is guided in the single-mode optical fiber in single-mode form having a first mode diameter and wherein the optical power density in the core of the single-mode fiber is greater than 10 MW/cm²;
(b) transmitting the optical beam through the interface between the single-mode optical fiber and the step-index, multi-mode optical fiber segment to the step-index, multi-mode optical fiber segment;
(c) expanding the optical beam in the step-index, multi-mode optical fiber segment between the single-mode optical fiber/step-index, multi-mode optical fiber segment interface and the exposed terminus of the multi-mode fiber segment, the step-index, multi-mode optical fiber segment being sized and composed such that the beam can expand to a diameter at the exposed terminus of the step-index, multi-mode optical fiber segment larger than the first mode diameter of the beam, without distortion of the beam or introduction of additional fiber modes; and
(d) transmitting the expanded beam through the exposed terminus of the step-index, multi-mode optical fiber segment at an optical power density less than that of the optical power density in the core of the single-mode fiber.

2. The method according to claim 1, wherein the beam undergoes an optical power intensity reduction in the step-index, multi-mode optical fiber segment of between 10× and 1000×.

3. The method according to claim 2, wherein the beam undergoes an optical power intensity reduction in the step-index, multi-mode optical fiber segment of at least 50×.

4. The method according to claim 2, wherein the beam undergoes an optical power intensity reduction in the step-index, multi-mode optical fiber segment of at least 100×.

5. The method according to claim 2, wherein the beam undergoes an optical power intensity reduction in the step-index, multi-mode optical fiber segment of at least 200×.

6. The method according to claim 1, wherein the step-index, multi-mode fiber segment has a length of less than 1 mm.

7. The method according to claim 1, wherein the step-index, multi-mode fiber segment has a length of less than 0.75 mm.

8. The method according to claim 1, wherein the single-mode optical fiber is a polarization maintaining fiber.

9. The method according to claim 1, wherein the exposed terminus of the step-index, multi-mode fiber includes an anti-reflection coating.

10. The method according to claim 1, wherein the step-index, multi-mode fiber segment is joined to the single-mode optical fiber by fusion splicing.

11. The method according to claim 1, wherein the step-index, multi-mode fiber is index matched to the single-mode optical fiber.

12. The method according to claim 1, wherein the step-index, multi-mode optical fiber segment comprises an air clad optical fiber having approximately similar diameter as the single-mode fiber.

13. The method according to claim 1, further comprising the step of lensing the optical beam after it is transmitted through the exposed terminus of the step-index, multi-mode optical fiber segment.

14. The method according to claim 1, wherein the optical power density in the core of the single-mode fiber is greater than 10 MW/cm and less than 10 GW/cm².

15. The method according to claim 14, wherein the optical power density in the core of the single-mode fiber is greater than 500 MW/cm².

16. The method according to claim 14, wherein the optical power density in the core of the single-mode fiber is greater than 1 GW/cm².

17. An apparatus for processing an optical beam having high optical power levels comprising:
(a) a single-mode optical fiber with cladding and a core joined to a step-index, multi-mode optical fiber segment at an interface there between, the step-index, multi-mode optical fiber segment being of a predetermined length and having an exposed terminus at an end thereof distal to the interface between the single-mode optical fiber and the step-index, multi-mode optical fiber segment,
wherein the single-mode fiber and step-index, multi-mode fiber segment are selected and configured such that a suitable optical beam provided to the single-mode optical fiber is guided in the single-mode optical fiber in single-mode form at a first mode diameter and transmitted through the interface between the single-mode optical fiber and the step-index, multi-mode optical fiber segment to the step-index, multi-mode optical fiber segment, whereupon the optical beam is expanded in the step-index, multi-mode optical fiber segment, between the single-mode optical fiber/step-index, multi-mode optical fiber segment interface and the exposed terminus of the multi-mode fiber segment,
the step-index, multi-mode optical fiber segment being sized and composed such that the suitable beam is expanded to a diameter at the exposed terminus of the step-index, multi-mode optical fiber segment larger than the first mode diameter of the suitable beam without distortion of the beam or introduction of additional fiber modes; and
(b) a lens in proximity to the exposed terminus of the step-index, multi-mode optical fiber beam adapted to collimate and transmit the beam for further processing.

18. The apparatus according to claim 17, wherein the step-index, multi-mode fiber segment has a length of les than 1 mm.

19. The apparatus according to claim 17, wherein the step-index, multi-mode fiber segment has a length of les than 0.75 mm.

20. The apparatus according to claim 17, wherein the single-mode optical fiber is a polarization maintaining fiber.
